(19) United States
(12) Patent Application Publication
(10) Pub. No.: US 2022/0415550 A1
(43) Pub. Date: Dec. 29, 2022

(54) Alloy Powders and Methods for Producing the Same

(71) Applicants: Neo Performance Materials (Sinapore) Pte. Ltd., Singapore (SG); Magnequench Tianjin Co., Ltd., Tianjin (CN)

(72) Inventors: Yong Keat Lim, Singapore (SG); Zhensheng Wu, Tianjin (CN); Mingqi Gu, Tianjin (CN); Zhongmin Chen, Singapore (SG)

(21) Appl. No.: 17/623,854

(22) PCT Filed: Apr. 13, 2020
(86) PCT No.: PCT/SG2020/050225

§ 371 Date: Dec. 29, 2021

(30) Foreign Application Priority Data
Mar. 25, 2020 (CN) 202010217586.2

(51) Int. Cl. H01F 1/057; B22F 1/142; B22F 1/145; B22F 9/04; B22F 3/02

(52) U.S. Cl. CPC H01F 1/0572; B22F 1/142; B22F 1/145; B22F 9/04; B22F 3/02; B22F 2009/045; B22F 2303/01; B22F 2009/041; B22F 2301/35

(57) ABSTRACT

The present invention relates to an alloy with formula of RE-M-B—Fe as defined herein and oxygen content less than 0.9 wt %, wherein said RE is in the range of 29.0 weight % to 33.0 weight %; M is in the range of 0.25 weight % to 1.0 weight %; B is in the range of 0.8 weight % to 1.1 weight %; and Fe makes up the balance. The present invention also relates to a method for preparing a RE-M-Fe—B magnetic powder, as defined herein comprising the steps of: (a) melt spinning a RE-M-Fe—B alloy composition to obtain a melt-spun powder; (b) pressing the melt-spun powder of step (a) to obtain a compact body; (c) hot deforming the compact body of step (b) to obtain a die-upset magnet; (d) crushing the die-upset magnet of step (c) to obtain a powder; (e) milling and sieving the powder of step (d); and (f) passivating the powder of step (e) to obtain a magnetic powder; wherein: each of steps (d) to (f) is performed under a low oxygen environment and transfer between each of steps (d) to (f) is a sealed transfer; and wherein the oxygen content of the low oxygen environment and during each sealed transfer is below 0.5 weight %.

### TECHNICAL FIELD

The present invention generally relates to alloy powders and methods for producing alloy powders.

### BACKGROUND

Rare-earth bonded magnets made from rare-earth magnetic alloy powder and polymer binder are used in numerous applications, including computer hardware, automobiles, consumer electronics, motors and household appliances. With the progress of technology, it is becoming increasingly necessary to produce magnets of improved magnetic performance. It is therefore desirable to have a process by which rare earth magnetic alloys powders and their bonded magnets are produced with improved magnetic performance that can be maintained at high temperature. Intrinsic coercive force (Hci) is a measurement of a magnet's resistance to demagnetization. A magnet with high Hci will be able to maintain its magnetic performance under elevated temperature and demagnetizing stress. For example, a minimum Hci of 17 kOe is generally necessary to maintain the magnetic performance of a magnet at 120° C. Nonetheless, current methods of preparing magnetic powder may not be able to achieve high enough Hci values.

Conventionally, heavy rare-earth metals such as dysprosium (Dy) are included in magnetic alloy powders to improve the Hci, however the high cost of Dy renders the use of Dy in the preparation of magnetic powders impractical, especially on a large scale.

Hydrogenation disproportionation desorption recombination (HDDR) methods may be used to prepare magnetic alloy powders without the use of heavy rare earth metals, and instead rely on the use of special grain boundary diffusion heat treatment steps. However, such methods are still insufficient for producing magnetic alloy powders that display desirable temperature resistance.

On the other hand, it is known that incorporating a larger portion of light rare earth metal into magnetic alloy powder can result in a higher Hci, however a higher portion of light rare earth metal can also reduce the chemical stability of the resultant magnetic alloy powder. This is because light rare earth metals are susceptible to oxidation, especially in the fine powders. In addition, increasing the proportion of light rare earth metal in magnetic alloy powder also increases the flammability of the powder, making it unsafe for use. This also increases the risk during transporting and handling the magnetic powder.

There is therefore a need to provide a magnetic alloy powder and methods for forming magnetic alloy powders that overcomes, or at least ameliorates, one or more of the disadvantages described above.

### SUMMARY

According to a first aspect, the present disclosure refers to an alloy powder with Formula (I) and oxygen content less than 0.9 wt %:

RE-M-B—Fe Formula (I)

wherein:
RE is one or more rare earth metals selected from the group consisting of lanthanum (La), cerium (Ce), neodymium (Nd), praseodymium (Pr), yttrium (Y), gadolinium (Gd), terbium (Tb), dysoprium (Dy), holmium (Ho), and ytterbium (Yb);
M is one or more metals selected from the group consisting of gallium (Ga), zirconium (Zr), niobium (Nb), molybdenum (Mo), titanium (Ti), vanadium (V), chromium (Cr), manganese (Mn), hafnium (Hf), tantalum (Ta), tungsten (W), copper (Cu), aluminum (Al), and cobalt (Co);
B is boron (B); and
Fe is iron (Fe);

wherein:
RE is in the range of 29.0 weight % to 33.0 weight %;
M is in the range of 0.25 weight % to 1.0 weight %;
B is in the range of 0.8 weight % to 1.1 weight %; and
Fe makes up the balance.

Advantageously, the alloy powders have a low oxygen content which improves the magnetic properties of the alloy powder, such as resulting in alloy powders with high remanence (Br) and Hci values.

Advantageously, the alloy powders may exhibit a Br value greater than 12 kG at a Hci value in the range of about 14 kOe to about 20 kOe.

Further advantageously, it is possible for cobalt (Co) and/or dysprosium (Dy) to be absent from the alloy powder. This is a departure from other alloy powders which rely on the incorporation of cobalt (Co) and/or heavy rare-earth metals such as dysprosium (Dy) for improved Hci which is costly. Hence, the alloy powders of the present disclosure may be substantially more cost-effective.

According to a second aspect, the present disclosure refers to a bonded magnet comprising the alloy powder disclosed herein and at least one binder selected from the group consisting of epoxy, polyamide, and polyphenylene sulfide.

According to a third aspect, the present disclosure refers to a method for preparing a RE-M-Fe—B magnetic powder, wherein:

RE is one or more rare earth metals selected from the group consisting of lanthanum (La), cerium (Ce), neodymium (Nd), praseodymium (Pr), yttrium (Y), gadolinium (Gd), terbium (Tb), dysoprium (Dy), holmium (Ho), and ytterbium (Yb);

M is one or more metals selected from the group consisting of gallium (Ga), zirconium (Zr), niobium (Nb), molybdenum (Mo), titanium (Ti), vanadium (V), chromium (Cr), manganese (Mn), hafnium (Hf), tantalum (Ta), tungsten (W), copper (Cu), and aluminum (Al), and cobalt;

B is boron (B); and

Fe is iron (Fe);

wherein the method comprises the steps of:

(a) melt spinning a RE-M-Fe—B alloy composition to obtain a melt-spun powder;

(b) pressing the melt-spun powder of step (a) to obtain a compact body;

(c) hot deforming the compact body of step (b) to obtain a die-upset magnet;

(d) crushing the die-upset magnet of step (c) to obtain a powder;

(e) milling and sieving the powder of step (d); and

(f) passivating the powder of step (e) to obtain a magnetic powder;

wherein:

each of steps (d) to (f) is performed under a low oxygen environment and transfer between each of steps (d) to (f) is a sealed transfer; and

wherein the oxygen content of the low oxygen environment and during each sealed transfer is below 0.5 weight %.

The methods disclosed herein may advantageously result in alloy powders with low oxygen content, such as below 0.9 wt %, which is desirable as it reduces the loss of magnetic properties due to metal oxidation, which in turn improves the magnetic properties of the magnetic powder, such as Hci and Br.

Advantageously, the methods disclosed herein may also advantageously result in magnetic powders with a reduced proportion of fine powders (such as −325 mesh powders).

Reduction of the proportion of fine powders is advantageous as the presence of fine powders in the magnetic powder result in poorer magnetic properties.

Also advantageously, the methods disclosed herein may result in magnetic powders that are less susceptible to oxidation and are non-hazardous, enabling them to be safe for transporting and handling.

### Definitions

The following words and terms used herein shall have the meaning indicated:

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

The present invention provides an alloy powder with Formula (I) and oxygen content less than 0.9 wt %:

RE-M-B—Fe Formula (I)

wherein:
RE is one or more rare earth metals selected from the group consisting of lanthanum (La), cerium (Ce), neodymium (Nd), praseodymium (Pr), yttrium (Y), gadolinium (Gd), terbium (Tb), dysoprium (Dy), holmium (Ho), and ytterbium (Yb);
M is one or more metals selected from the group consisting of gallium (Ga), zirconium (Zr), niobium (Nb), molybdenum (Mo), titanium (Ti), vanadium (V), chromium (Cr), manganese (Mn), hafnium (Hf), tantalum (Ta), tungsten (W), copper (Cu), aluminum (Al), and cobalt (Co);
B is boron (B); and
Fe is iron (Fe);

wherein:
RE is in the range of 29.0 weight % to 33.0 weight %;
M is in the range of 0.25 weight % to 1.0 weight %;
B is in the range of 0.8 weight % to 1.1 weight %; and
Fe makes up the balance.

The disclosed alloy powder may have oxygen content less than about 0.9 wt %, less than about 0.8 wt %, less than about 0.7 wt %, less than about 0.6 wt %, less than about 0.5 wt %, less than about 0.4 wt %, less than about 0.3 wt %, less than about 0.2 wt %, or less than about 0.1 wt %. The disclosed alloy powder may have oxygen content in the range of about 0.5 wt % to about 0.6 wt %, about 0.51 wt % to about 0.6 wt %, about 0.52 wt % to about 0.6 wt %, about 0.53 wt % to about 0.6 wt %, about 0.54 wt % to about 0.6 wt %, about 0.55 wt % to about 0.6 wt %, about 0.56 wt % to about 0.6 wt %, about 0.57 wt % to about 0.6 wt %, about 0.58 wt % to about 0.6 wt %, about 0.59 wt % to about 0.6 wt %, about 0.5 wt % to about 0.59 wt %, about 0.5 wt % to about 0.58 wt %, about 0.5 wt % to about 0.57 wt %, about 0.5 wt % to about 0.56 wt %, about 0.5 wt % to about 0.55 wt %, about 0.5 wt % to about 0.54 wt %, about 0.5 wt % to about 0.53 wt %, about 0.5 wt % to about 0.52 wt %, about 0.5 wt % to about 0.51 wt %, about 0.5 wt %, about 0.51 wt %, about 0.52 wt %, about 0.53 wt %, about 0.54 wt %, about 0.55 wt %, about 0.56 wt %, about 0.57 wt %, about 0.58 wt %, about 0.59 wt %, about 0.6 wt %, about 0.61 wt %, about 0.62 wt %, about 0.63 wt %, about 0.64 wt %, about 0.65 wt %, about 0.66 wt %, about 0.67 wt %, about 0.68 wt %, about 0.69 wt %, about 0.7 wt %, about 0.71 wt %, about 0.72 wt %, about 0.73 wt %, about 0.74 wt %, about 0.75 wt %, about 0.76 wt %, about 0.77 wt %, about 0.78 wt %, about 0.79 wt %, about 0.8 wt %, about 0.81 wt %, about 0.82 wt %, about 0.83 wt %, about 0.84 wt %, about 0.85 wt %, about 0.86 wt %, about 0.87 wt %, about 0.88 wt %, about 0.89 wt %, or about 0.9 wt %. It is to be appreciated that the above ranges should be interpreted as including and supporting any sub-ranges or discrete values (which may or may not be a whole number) that are within the stated range(s).

RE in the alloy powder rare earth metal content in the range of about 29.0 weight % to about 33.0 weight %, about 29.5 weight % to about 33.0 weight %, about 30.0 weight % to about 33.0 weight %, about 30.5 weight % to about 33.0 weight %, about 31.0 weight % to about 33.0 weight %, about 31.5 weight % to about 33.0 weight %, about 32.0 weight % to about 33.0 weight %, about 32.5 weight % to about 33.0 weight %, about 29.0 weight % to about 32.5 weight %, about 29.0 weight % to about 32.0 weight %, about 29.0 weight % to about 31.5 weight %, about 29.0 weight % to about 31.0 weight %, about 29.0 weight % to about 30.5 weight %, about 29.0 weight % to about 30.0 weight %, about 29.0 weight % to about 29.5 weight %, about 30.0 wt % to about 32.5 wt %, about 30.40 wt % to about 32.45 wt %, about 30.5 wt % to about 32.5 wt %, about 31.0 wt % to about 32.5 wt %, about 31.5 wt % to about 32.5 wt %, about 32.0 wt % to about 32.5 wt %, about 30.0 wt % to about 32.0 wt %, about 30.0 wt % to about 31.5 wt %, about 30.0 wt % to about 31.0 wt %, about 30.6 weight % to about 31.8 weight %, about 30.7 weight % to about 31.8 weight %, about 30.8 weight % to about 31.8 weight %, about 30.9 weight % to about 31.8 weight %, about 31.0 weight % to about 31.8 weight %, about 31.1 weight % to about 31.8 weight %, about 31.2 weight % to about 31.8 weight %, about 31.3 weight % to about 31.8 weight %, about 31.4 weight % to about 31.8 weight %, about 31.5 weight % to about 31.8 weight %, about 31.6 weight % to about 31.8 weight %, about 31.7 weight % to about 31.8 weight %, about 30.6 weight % to about 31.7 weight %, about 30.6 weight % to about 31.6 weight %, about 30.6 weight % to about 31.5 weight %, about 30.6 weight % to about 31.4 weight %, about 30.6 weight % to about 31.3 weight %, about 30.6 weight % to about 31.2 weight %, about 30.6 weight % to about 31.1 weight %, about 30.6 weight % to about 31.0 weight %, about 30.6 weight % to about 30.9 weight %, about 29.0 weight % to about 29.5 weight %, about 29.0 weight %, about 29.5 weight %, about 30.0 weight %, about 30.45 weight %, about 30.5 weight %, about 30.6 weight %, about 30.7 weight %, about 30.8 weight %, about 30.9 weight %, about 31.0 weight %, about 31.1 weight %, about 31.2 weight %, about 31.3 weight %, about 31.4 weight %, about 31.45 weight %, about 31.5 weight %, about 31.6 weight %, about 31.7 weight %, about 31.8 weight %, about 31.9 weight %, about 32.0 weight %, about 32.4 weight %, about 32.5 weight %, or about 33.0 weight %. It is to be appreciated that the above ranges should be interpreted as including and supporting any sub-ranges or discrete values (which may or may not be a whole number) that are within the stated range(s).

M in the alloy powder may be in the range of about 0.25 weight % to about 1.0 weight %, about 0.3 weight % to about 1.0 weight %, about 0.35 weight % to about 1.0 weight %, about 0.4 weight % to about 1.0 weight %, about 0.45 weight % to about 1.0 weight %, about 0.5 weight % to about 1.0 weight %, about 0.55 weight % to about 1.0 weight %, about 0.6 weight % to about 1.0 weight %, about 0.65 weight % to about 1.0 weight %, about 0.7 weight % to about 1.0 weight %, about 0.75 weight % to about 1.0 weight %, about 0.8 weight % to about 1.0 weight %, about 0.85 weight % to about 1.0 weight %, about 0.9 weight % to about 1.0 weight %, about 0.95 weight % to about 1.0 weight %, about 0.25 weight % to about 0.95 weight %, about 0.25 weight % to about 0.90 weight %, about 0.25 weight % to about 0.85 weight %, about 0.25 weight % to about 0.80 weight %, about 0.25 weight % to about 0.75 weight %, about 0.25 weight % to about 0.70 weight %, about 0.25 weight % to about 0.65 weight %, about 0.25 weight % to about 0.60 weight %, about 0.25 weight % to about 0.55 weight %, about 0.25 weight % to about 0.50 weight %, about 0.25 weight % to about 0.45 weight %, about 0.25 weight % to about 0.40 weight %, about 0.25 weight % to about 0.35 weight %, about 0.25 weight % to about 0.30 weight %, about 0.50 weight % to about 0.75 weight %, about 0.55 weight % to about 0.75 weight %, about 0.60 weight % to about 0.75 weight %, about 0.65 weight % to about 0.75 weight %, about 0.70 weight % to about 0.75 weight %, about 0.50 weight % to about 0.70 weight %, about 0.50 weight % to about 0.65 weight %, about 0.50 weight % to about 0.60 weight %, about 0.50 weight % to about 0.55 weight %, about 0.45 weight % to about 0.55 weight %, about 0.46 weight % to about 0.55 weight %, about 0.47 weight % to about 0.55 weight %, about 0.48 weight % to about 0.55 weight %, about 0.49 weight % to about 0.55 weight %, about 0.50 weight % to about 0.55 weight %, about 0.51 weight % to about 0.55 weight %, about 0.52 weight % to about 0.55 weight %, about 0.53 weight % to about 0.55 weight %, about 0.54 weight % to about 0.55 weight %, about 0.45 weight % to about 0.54 weight %, about 0.45 weight % to about 0.53 weight %, about 0.45 weight % to about 0.52 weight %, about 0.45 weight % to about 0.51 weight %, about 0.45 weight % to about 0.50 weight %, about 0.45 weight % to about 0.49 weight %, about 0.25 weight %, about 0.30 weight %, about 0.35 weight %, about 0.40 weight %, about 0.45 weight %, about 0.46 weight %, about 0.47 weight %, about 0.48 weight %, about 0.49 weight %, about 0.50 weight %, about 0.51 weight %, about 0.52 weight %, about 0.53 weight %, about 0.54 weight %, about 0.55 weight %, about 0.60 weight %, about 0.63 weight %, about 0.65 weight %, about 0.70 weight %, about 0.75 weight %, about 0.78 weight %, about 0.80 weight %, about 0.85 weight %, about 0.90 weight %, about 0.95 weight %, or about 1.0 weight %. It is to be appreciated that the above ranges should be interpreted as including and supporting any sub-ranges or discrete values (which may or may not be a whole number) that are within the stated range(s).

The disclosed alloy powder may have corresponding B or Boron element content in the range of about 0.8 weight % to about 1.1 weight %, 0.85 weight % to about 1.1 weight %, 0.9 weight % to about 1.1 weight %, 0.95 weight % to about 1.1 weight %, 1.0 weight % to about 1.1 weight %, 1.05 weight % to about 1.1 weight %, about 0.8 weight % to about 1.05 weight %, about 0.8 weight % to about 1.0 weight %, about 0.8 weight % to about 0.95 weight %, about 0.8 weight % to about 0.9 weight %, about 0.8 weight % to about 0.85 weight %, about 0.9 weight % to about 1.0 weight %, about 0.91 weight % to about 1.0 weight %, about 0.92 weight % to about 1.0 weight %, about 0.93 weight % to about 1.0 weight %, about 0.94 weight % to about 1.0 weight %, about 0.95 weight % to about 1.0 weight %, about 0.96 weight % to about 1.0 weight %, about 0.97 weight % to about 1.0 weight %, about 0.98 weight % to about 1.0 weight %, about 0.99 weight % to about 1.0 weight %, about 0.9 weight % to about 0.99 weight %, about 0.9 weight % to about 0.98 weight %, about 0.9 weight % to about 0.97 weight %, about 0.9 weight % to about 0.96 weight %, about 0.9 weight % to about 0.95 weight %, about 0.9 weight % to about 0.94 weight %, about 0.9 weight % to about 0.93 weight %, about 0.9 weight % to about 0.92 weight %, about 0.9 weight % to about 0.91 weight %, about 0.885 weight % to about 0.945 weight %, about 0.890 weight % to about 0.945 weight %, about 0.895 weight % to about 0.945 weight %, about 0.900 weight % to about 0.945 weight %, about 0.905 weight % to about 0.945 weight %, about 0.910 weight % to about 0.945 weight %, about 0.915 weight % to about 0.945 weight %, about 0.920 weight % to about 0.945 weight %, about 0.925 weight % to about 0.945 weight %, about 0.930 weight % to about 0.945 weight %, about 0.935 weight % to about 0.945 weight %, about 0.940 weight % to about 0.945 weight %, about 0.885 weight % to about 0.940 weight %, about 0.885 weight % to about 0.935 weight %, about 0.885 weight % to about 0.930 weight %, about 0.885 weight % to about 0.925 weight %, about 0.885 weight % to about 0.920 weight %, about 0.885 weight % to about 0.915 weight %, about 0.885 weight % to about 0.910 weight %, about 0.885 weight % to about 0.905 weight %, about 0.885 weight % to about 0.900 weight %, about 0.885 weight % to about 0.895 weight %, about 0.885 weight % to about 0.890 weight %, about 0.8 weight %, about 0.85 weight %, about 0.885 weight %, about 0.890 weight %, about 0.895 weight %, about 0.900 weight %, about 0.905 weight %, about 0.910 weight %, about 0.915 weight %, about 0.920 weight %, about 0.925 weight %, about 0.930 weight %, about 0.935 weight %, about 0.940 weight %, or about 0.945 weight %, about 0.95 weight %, about 0.96 weight %, about 0.97 weight %, about 0.98 weight %, about 0.99 weight %, about 1.0 weight %, about 1.05 weight %, or about 1.1 weight %. It is to be appreciated that the above ranges should be interpreted as including and supporting any sub-ranges or discrete values (which may or may not be a whole number) that are within the stated range(s).

In Formula (I), RE may be in the range of 30.0 wt % to 32.5 wt %, M may be in the range of 0.50 weight % to 0.75 weight %, B may be in the range of 0.9 weight % to 1.0 weight %, and Fe may make up the balance.

In Formula (I), RE may be in the range of 30.45 weight % to 32.45 weight %, M may be in the range of 0.45 weight % to 0.55 weight %, B may be in the range of 0.885 weight % to 0.945 weight %, and Fe may make up the balance.

Cobalt (Co) or dysprosium (Dy) may be absent from Formula (I). This is advantageous as Co and Dy are costly and hence their use in magnetic powders is impractical, especially for mass production.

RE may be selected from the group consisting of:

(i) Nd;

(ii) Nd, Pr;

(iii) Nd, Pr, La;

(iv) Nd, Pr, Ce;

(v) Nd, Pr, La, Ce;

(vi) Nd, La;

(vii) Nd, Ce;

(viii) Nd, Ce, La;

(ix) Pr;

(x) Pr, La;

(xi) Pr, Ce; and

(xii) Pr, La, Ce.

Formula (I) may be selected from the group consisting of:

(i) Nd—Ga—Fe—B;

(ii) Pr—Ga—Fe—B;

(iii) (NdPr)—Ga—Fe—B;

(iv) Nd—Cu—Fe—B;

(v) Pr—Cu—Fe—B;

(vi) (NdPr)—Cu—Fe—B;

(vii) Nd—Al—Fe—B;

(viii) Pr—Al—Fe—B; and

(ix) (NdPr)—Al—Fe—B.

The alloy powder may be selected from the group consisting of:
NdPr—Ga—B—Fe, wherein RE is 30.45 wt %, Ga is 0.53 wt %, B is 0.94 wt %, and Fe is 68.08 wt %;
NdPr—Ga—B—Fe, wherein RE is 31.45 wt %, Ga is 0.53 wt %, B is 0.93 wt %, and Fe is 67.09 wt %;
NdPr—Ga—B—Fe, wherein RE is 31.9 wt %, Ga is 0.63 wt %, B is 0.92 wt %, and Fe is 66.55 wt %; and
NdPr—Ga—B—Fe, wherein RE is 32.4 wt %, Ga is 0.78 wt %, B is 0.91 wt %, and Fe is 65.91 wt %.

In the disclosed alloy powder, the percentage of particles of −325 mesh (45 microns) may be up to about 30% of the particles, up to about 25% of the particles, up to about 20% of the particles, up to about 15% of the particles, up to about 10% of the particles, up to about 5%, or about 0%. The percentage of particles of −325 mesh may be about 0%, about 1%, about 2%, about 3%, about 4%, about 5%, about 6%, about 7%, about 8%, about 9%, about 10%, about 1%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, or about 30%. The remaining particles may be −80 mesh (180 microns) to −325 mesh. It is to be appreciated that the above ranges should be interpreted as including and supporting any sub-ranges or discrete values (which may or may not be a whole number) that are within the stated range(s).

In the disclosed alloy powder, the percentage of particles of −325 mesh may be 30%, and the percentage of particles of −80 mesh to −325 mesh may be 70%.

The disclosed alloy powder may be an anisotropic magnetic powder.

The inventors have surprising found that the disclosed anisotropic magnetic powder may exhibit a high remanence (Br) value and high coercivity (Hci) values, even in the absence of cobalt (Co) or dysprosium (Dy) which are costly and hence increase the cost of production. Having a high Br value is advantageous as it indicates larger available flux output from the magnet. Having a high Hci value is also advantageous as it indicates that the magnet is highly resistant to demagnetization.

The disclosed anisotropic magnetic powder may exhibit a remanence (Br) value greater than 12 kG at a coercivity (Hci) value in the range of about 14 kOe to about 20 kOe.

The remanence (Br) value of the anisotropic magnetic powder may be in the range of about 12 kG to about 14 kG, about 12.1 kG to about 14 kG, about 12.2 kG to about 14 kG, about 12.3 kG to about 14 kG, about 12.4 kG to about 14 kG, about 12.5 kG to about 14 kG, about 12.6 kG to about 14 kG, about 12.7 kG to about 14 kG, about 12.8 kG to about 14 kG, about 12.9 kG to about 14 kG, about 13.0 kG to about 14 kG, about 13.1 kG to about 14 kG, about 13.2 kG to about 14 kG, about 13.3 kG to about 14 kG, about 13.4 kG to about 14 kG, about 13.5 kG to about 14 kG, about 13.6 kG to about 14 kG, about 13.7 kG to about 14 kG, about 13.8 kG to about 14 kG, about 13.9 kG to about 14 kG, about 12 kG to about 13.9 kG, about 12 kG to about 13.8 kG, about 12 kG to about 137 kG, about 12 kG to about 13.6 kG, about 12 kG to about 13.5 kG, about 12 kG to about 13.4 kG, about 12 kG to about 13.3 kG, about 12 kG to about 13.2 kG, about 12 kG to about 13.1 kG, about 12 kG to about 13.0 kG, about 12 kG to about 12.9 kG, about 12 kG to about 12.8 kG, about 12 kG to about 12.7 kG, about 12 kG to about 12.6 kG, about 12 kG to about 12.5 kG, about 12 kG to about 12.4 kG, about 12 kG to about 12.3 kG, about 12 kG to about 12.2 kG, about 12 kG to about 12.1 kG, or about 12 kG, about 12.1 kG, about 12.2 kG, about 12.3 kG, about 12.4 kG, about 12.5 kG, about 12.6 kG, about 12.7 kG, about 12.8 kG, about 12.9 kG, about 13.0 kG, about 13.1 kG, about 13.2 kG, about 13.3 kG, about 13.4 kG, about 13.5 kG, about 13.6 kG, about 13.7 kG, about 13.8 kG, about 13.9 kG, or about 14.0 kG. It is to be appreciated that the above ranges should be interpreted as including and supporting any sub-ranges or discrete values (which may or may not be a whole number) that are within the stated range(s).

The coercivity (Hci) value of the anisotropic magnetic powder may be in the range of about 14 kOe to about 20 kOe, about 15 kOe to about 20 kOe, about 16 kOe to about 20 kOe, about 17 kOe to about 20 kOe, about 18 kOe to about 20 kOe, about 19 kOe to about 20 kOe, about 15 kOe to about 20 kOe, about 16 kOe to about 20 kOe, about 17 kOe to about 20 kOe, about 18 kOe to about 20 kOe, about 19 kOe to about 20 kOe, about 14 kOe, about 14.5 kOe, about 15 kOe, about 15.5 kOe, about 16 kOe, about 16.5 kOe, about 17 kOe, about 17.5 kOe, about 18 kOe, about 18.5 kOe, about 19 kOe, about 19.5 kOe, or about 20 kO3. It is to be appreciated that the above ranges should be interpreted as including and supporting any sub-ranges or discrete values (which may or may not be a whole number) that are within the stated range(s).

The disclosed anisotropic magnetic powder may exhibit a remanence (Br) value greater than 13 kG at a coercivity (Hci) value of 15 kOe, about 13 kG at 17 kOe, about 12.7 kG at 19 kOe, and/or about 12.5 kG at 19.5 kOe.

The inventors have surprisingly made a magnetic powder that possesses uniquely high Hci values. These high Hci values are even demonstrated in magnetic powders without expensive Co and Dy.

The present invention further provides a bonded magnet comprising the alloy powder disclosed herein. The bonded magnet may comprise at least one binder. The binder may be selected from the group consisting of epoxy, polyamide, and polyphenylene sulfide.

The present invention provides a method for preparing a RE-M-Fe—B magnetic powder, wherein:

RE is one or more rare earth metals selected from the group consisting of lanthanum (La), cerium (Ce), neodymium (Nd), praseodymium (Pr), yttrium (Y), gadolinium (Gd), terbium (Tb), dysoprium (Dy), holmium (Ho), and ytterbium (Yb); M is one or more metals selected from the group consisting of gallium (Ga), zirconium (Zr), niobium (Nb), molybdenum (Mo), titanium (Ti), vanadium (V), chromium (Cr), manganese (Mn), hafnium (Hf), tantalum (Ta), tungsten (W), copper (Cu), and aluminum (Al), and cobalt;

B is boron (B); and

Fe is iron (Fe);

wherein the method comprises the steps of:

(a) melt spinning a RE-M-Fe—B alloy composition to obtain a melt-spun powder;

(b) pressing the melt-spun powder of step (a) to obtain a compact body;

(c) hot deforming the compact body of step (b) to obtain a die-upset magnet;

(d) crushing the die-upset magnet of step (c) to obtain a powder;

(e) milling and sieving the powder of step (d); and

(f) passivating the powder of step (e) to obtain a magnetic powder;

wherein:

each of steps (d) to (f) is performed under a low oxygen environment and transfer between each of steps (d) to (f) is a sealed transfer; and

wherein the oxygen content of the low oxygen environment and during each sealed transfer is below 0.5 weight %.

In the disclosed method, each of steps (d) to (f) may be performed under a low oxygen environment. The transfer between each of steps (d) to (f) may be a sealed transfer. In the disclosed method, each of steps (c) to (f) may also be performed under a low oxygen environment. The transfer between each of steps (c) to (f) may also be a sealed transfer.

The oxygen content of low oxygen environment and during each sealed transfer in the disclosed method may be below about 0.5 weight %, below about 0.45 weight %, below about 0.4 weight %, below about 0.35 weight %, below about 0.3 weight %, below about 0.25 weight %, below about 0.2 weight %, below about 0.15 weight %, below about 0.1 weight %, or below about 0.05 weight %. It is to be appreciated that the above ranges should be interpreted as including and supporting any sub-ranges or discrete values (which may or may not be a whole number) that are within the stated range(s). The oxygen content of the low oxygen environment and during each sealed transfer may be below about 0.1 weight %, below about 0.09 weight %, below about 0.08 weight %, below about 0.07 weight %, below about 0.06 weight %, below about 0.05 weight %, below about 0.04 weight %, below about 0.03 weight %, below about 0.02 weight %, or below about 0.01 weight %. It is to be appreciated that the above ranges should be interpreted as including and supporting any sub-ranges or discrete values (which may or may not be a whole number) that are within the stated range(s).

The inventors have surprisingly found that performing each of steps (d) to (f) under a low oxygen environment and using a sealed transfer between each of steps (d) to (f) lowers the oxygen content of the resultant magnetic powder. Magnetic metal elements such as Fe and Nd in the magnetic powder oxidize in the presence of oxygen to form metal oxides which are non-magnetic. This oxidation process is detrimental to the magnetic performance of the magnetic powder. Having low oxygen content in magnetic powder is advantageous as it reduces undesirable oxidation of metal elements (such as Fe and Nd) in the magnetic powder.

The resulting magnetic powder may have oxygen content less than about 0.9 wt %, less than about 0.8 wt %, less than about 0.7 wt %, less than about 0.6 wt %, less than about 0.5 wt %, less than about 0.4 wt %, less than about 0.3 wt %, less than about 0.2 wt %, or less than about 0.1 wt %. The disclosed alloy powder may have oxygen content in the range of about 0.5 wt % to about 0.6 wt %, about 0.51 wt % to about 0.6 wt %, about 0.52 wt % to about 0.6 wt %, about 0.53 wt % to about 0.6 wt %, about 0.54 wt % to about 0.6 wt %, about 0.55 wt % to about 0.6 wt %, about 0.56 wt % to about 0.6 wt %, about 0.57 wt % to about 0.6 wt %, about 0.58 wt % to about 0.6 wt %, about 0.59 wt % to about 0.6 wt %, about 0.5 wt % to about 0.59 wt %, about 0.5 wt % to about 0.58 wt %, about 0.5 wt % to about 0.57 wt %, about 0.5 wt % to about 0.56 wt %, about 0.5 wt % to about 0.55 wt %, about 0.5 wt % to about 0.54 wt %, about 0.5 wt % to about 0.53 wt %, about 0.5 wt % to about 0.52 wt %, about 0.5 wt % to about 0.51 wt %, about 0.5 wt %, about 0.51 wt %, about 0.52 wt %, about 0.53 wt %, about 0.54 wt %, about 0.55 wt %, about 0.56 wt %, about 0.57 wt %, about 0.58 wt %, about 0.59 wt %, about 0.6 wt %, about 0.61 wt %, about 0.62 wt %, about 0.63 wt %, about 0.64 wt %, about 0.65 wt %, about 0.66 wt %, about 0.67 wt %, about 0.68 wt %, about 0.69 wt %, about 0.7 wt %, about 0.71 wt %, about 0.72 wt %, about 0.73 wt %, about 0.74 wt %, about 0.75 wt %, about 0.76 wt %, about 0.77 wt %, about 0.78 wt %, about 0.79 wt %, about 0.8 wt %, about 0.81 wt %, about 0.82 wt %, about 0.83 wt %, about 0.84 wt %, about 0.85 wt %, about 0.86 wt %, about 0.87 wt %, about 0.88 wt %, about 0.89 wt %, or about 0.9 wt %.

It is to be appreciated that the above ranges should be interpreted as including and supporting any sub-ranges or discrete values (which may or may not be a whole number) that are within the stated range(s).

In step (a), a RE-M-Fe—B alloy composition may be melt spun to obtain a melt spun powder. The RE-M-Fe—B alloy composition may be in the form of an ingot. The RE-M-Fe—B alloy composition (or ingot) may be prepared by weighing the appropriate amount of raw materials (such as Nd, Fe, Ga, Fe—B) according to the composition formula, placing the raw materials into a melter, melting the respective raw materials under inert atmosphere (such as argon atmosphere) and cooling it to obtain ingots. The ingots may be subsequently broken into pieces and loaded into a melt-spinner. The alloy ingots may be then heated up and re-melted in inert atmosphere (such as argon atmosphere) and ejected onto a rotating metal wheel to form ribbons. The melt-spun ribbons may then be crushed to powder to form the melt-spun powder.

In step (b), the melt-spun powder of step (a) may be pressed to obtain a dense, compact body. Lubricant (such as Li-St) may be mixed with the melt-spun powder of step (a) prior to pressing.

Step (b) may comprise a cold press and/or hot press. Step (b) may comprise the steps of:

(bi) cold pressing the melt-spun powder of step (a); and
(bii) hot pressing the cold-pressed powder of step (bi) to form the compact body.

In step (bi), the melt-spun body of step (a) may be pressed into a low density platform to form a low density compact body. Step (bi) may be performed at room temperature and normal atmosphere. The lubed melt-spun powder may be pressed into a cold-pressed powder using a hydraulic cold press.

The cold-pressed powder of step b(i) may be lubricated prior to hot pressing. An alcohol mixture prepared from graphite, boron nitride and alcohol may be sprayed onto the cold-pressed powder and evaporated.

In step (bii), the cold pressed compact body may be pressed into a hot press die to form a full density compact body. Step (bii) may be performed in inert atmosphere comprising argon, helium, or mixtures thereof.

In step (c), the full density compact body of step (b) may be pressed into a die cavity of larger diameter and hot deformed into a larger die at elevated temperature. This process may cause bulk lateral plastic flow, reducing the ribbon thickness and a controlled elongation of the nano-scale Nd₂Fe₁₄B grains. The resultant die-upset magnets are fully dense like the hot-pressed compact body but are strongly anisotropic in magnetic performance. The magnetic performance and deformability are dependent on ribbon composition and process parameters such as strain rate, working temperature, and degree of deformation. The die-upset magnet may have a 60 to 80% height reduction as compared to the hot-pressed compact body.

Step (c) may be performed in inert atmosphere comprising argon, helium, or mixtures thereof.

Both steps (bii) and (c) may be performed in inert atmosphere comprising argon, helium, or mixtures thereof. It has been surprisingly found that by performing the steps under inert gas protection, metals in alloy are less susceptible to oxidation. This reduces the formation of non-magnetic metal oxides and hence improves magnetic properties of the magnetic powder.

In step (d), the die-upset magnet of step (c) is crushed for breaking down the die-upset magnet into smaller pieces for better feeding into step (e). The crushing step may be a jaw-crushing step. Jaw crushing may be performed between jaw plates under inert gas protection.

Before jaw-crushing, the die-upset magnet of step (c) may be sandblasted to remove surface dirt and lube. The die-upset magnet of step (c) may be transferred under sealed transfer nitrogen environment to the jaw crusher step (d). During the crushing step, big pieces of die-upset magnet may be broken down into smaller pieces under nitrogen protection. The resultant crushed die-upset magnets may be collected in a sealed transfer container for transferring to step (e) for sieving and milling.

In step (e), the jaw-crushed powder of step (d) may be subjected to milling and sieving under inert gas protection with oxygen content below 0.5%. The milling step further reduces the size of the jaw-crushed powder and the sieving step screens the particles to a desired size Step (e) may comprise sieving the powder on a sieve unit with means for prolonging the residence time of said powder. The means of prolonging residence time of said powder may be a sieve bar which may be placed on the screen during the sieving process. The means may be an elongated and flexible material which is configured to be placed on the sieve unit for altering and lengthening the motion path of the powder particles on the sieve unit, therefore prolonging the residence time of said powder. The means may be an S-shaped sieve bar, or a concentric-shaped sieve bar, or a sieve bar that has a combination of S-shape and concentric-shape.

Due to the presence of the sieve bar, the residence time of the powders on the sieve unit may be prolonged by about 1.8 to about 2.2 times as compared to sieving the powder on the sieve unit without the sieve bar. The residence time of the powders on the sieve unit may be prolonged by about 1.9 to about 2.2 times, about 2.0 to about 2.2 times, about 2.1 to about 2.2 times, about 1.8 to about 2.1 times, about 1.8 to about 2.0 times, about 1.8 to about 1.9 times, about 1.8 times, about 1.9 times, about 2.0 times, about 2.1 times, or about 2.2 times. It is to be appreciated that the above ranges should be interpreted as including and supporting any sub-ranges or discrete values (which may or may not be a whole number) that are within the stated range(s).

The distance travelled by the powders on the sieve unit may be increased by about 1.3 to about 1.5 times as compared to sieving the powder on the sieve unit without the sieve bar. The distance travelled by the powders on the sieve unit may be increased by about 1.35 to about 1.5 times, about 1.4 to about 1.5 times, about 1.45 to about 1.5 times, about 1.3 to about 1.45 times, about 1.3 to about 1.4 times, about 1.3 to about 1.35 times, about 1.3 times, about 1.35 times, about 1.4 times, or about 1.45 times. It is to be appreciated that the above ranges should be interpreted as including and supporting any sub-ranges or discrete values (which may or may not be a whole number) that are within the stated range(s).

The inventors have surprisingly found that prolonging the residence time of the powders on the sieve unit results in a reduced proportion of fines in the magnetic powder. This may be achieved as it avoids re-milling of flakes which are supposed to be sieved out. Fines are known to exhibit poor magnetic properties. Having reduced portion of fines in the powder is advantageous as it improves the overall magnetic performance of the magnetic powder such as Br and Hci.

In step (f), the powder of step (e) may be subjected to passivating with phosphoric acid under shaft rotation and inert gas protection.

The disclosed method may also comprise passivating the powder with phosphoric acid at a concentration of at least 0.25 wt % in step (f) of the method. The concentration of the phosphoric acid in the disclosed method may be at least about 0.25 wt %, at least about 0.26 wt %, at least about 0.27 wt %, at least about 0.28 wt %, at least about 0.29 wt %, at least about 0.30 wt %, at least about 0.31 wt %, at least about 0.32 wt %, at least about 0.33 wt %, at least about 0.34 wt %, at least about 0.35 wt %, at least about 0.36 wt %, at least about 0.37 wt %, at least about 0.38 wt %, at least about 0.39 wt %, at least about 0.40 wt %, at least about 0.41 wt %, at least about 0.42 wt %, at least about 0.43 wt %, at least about 0.44 wt %, at least about 0.45 wt %, at least about 0.46 wt %, at least about 0.47 wt %, at least about 0.48 wt %, at least about 0.49 wt %, at least about 0.50 wt %, at least about 0.51 wt %, at least about 0.52 wt %, at least about 0.53 wt %, at least about 0.54 wt %, at least about 0.55 wt %, at least about 0.56 wt %, at least about 0.57 wt %, at least about 0.58 wt %, at least about 0.59 wt %, or at least about 0.60 wt %. It is to be appreciated that the above ranges should be interpreted as including and supporting any sub-ranges or discrete values (which may or may not be a whole number) that are within the stated range(s).

The inventors have surprising found that at least 0.25 wt % of phosphoric acid is effective and sufficient in protecting the magnetic powder from oxidation. Metal oxidation is undesirable as metal oxides, unlike metals, do not exhibit magnetic properties. Conventionally, the phosphating step prevents the oxidation of iron in the magnetic powder to iron oxide. Using 0.25 wt % of phosphoric acid for passivation not only prevents magnetic powder from forming undesired iron oxide but also prevents magnetic powder from forming neodymium oxide. Reducing oxidation of both neodymium and iron is beneficial as it improves magnetic performance of the magnetic powder. Also advantageously, using at least 0.25 wt % of phosphoric acid allows a phosphate protective layer to be formed around each metal particle without corroding the particles.

The disclosed method may also comprise passivating the powder with phosphoric acid at a concentration of 0.4 wt %. The inventors have surprisingly found that by passivating the magnetic powder in 0.4 wt % of phosphoric acid, the resultant magnetic powder may be non-hazardous which allows it to be safely handled and transported.

The sealed transfer of the disclosed method may be carried out using a container comprising means for sealed connection with equipment used in steps (d) to (f), means for sealed collection and release from the container after each step; and means for supplying an inert gas into the container. The sealed transfer container may be any enclosure which provides an air-tight seal. The sealed transfer container may be a stainless steel container. The means for sealed connection with equipment or supplying an inert gas into the container may be valves, switches or any other form of openings on the container which may be opened or closed through adjustment. The means for sealed connection may be stainless steel valves. The type of connection between the sealed transfer valves and equipment or gas supply may be flange connection, screw connection or welded end connection.

The inert gas of the disclosed method may be selected from a group consisting of argon, nitrogen, helium, and mixtures thereof.

The disclosed method may be used to prepare a RE-M-Fe—B magnetic powder of the alloy powder disclosed herein.

### BRIEF DESCRIPTION OF DRAWINGS

The accompanying drawings illustrate disclosed embodiments and serves to explain the principles of the disclosed embodiments. It is to be understood, however, that the drawings are designed for purposes of illustration only, and not as a definition of the limits of the invention.

FIG. 1 shows a process flow chart of the steps involved in the disclosed method for preparing a magnetic powder.

FIG. 2 shows the schematics of connection of the sealed transfer container to (a) crushing equipment, (b) milling and sieving equipment and (c) passivating equipment.

FIG. 3 shows a comparison between the Br of comparative magnetic powders (1a, 1b, 1c, 1d) and magnetic powder prepared using the method disclosed in Example 1 (2a, 2b, 2c, 2d).

FIGS. 4a and 4b show a schematic of embodiments of a sieve bar.

### DETAILED DESCRIPTION OF DRAWINGS

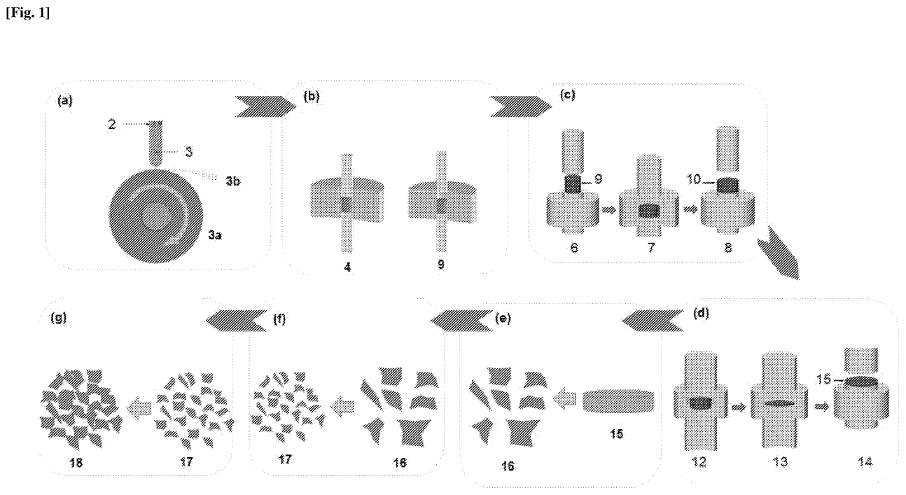

Referring to FIG. 1, FIG. 1(a) illustrates step (a) of the disclosed method. FIG. 1(a) shows a melt spinning process to obtain melt spun powder from alloy composition, depicting the flow of a melt of alloy composition (2) through a nozzle (3) onto a rotating wheel (3a) to form ribbons which are ejected from the wheel (3b) and then crushed to form powder. FIG. 1(b) illustrates step (bi) of the disclosed method, wherein the melt spun powder of step (a) is subjected to cold-pressing (4) to form a pressed powder (9). FIG. 1(c) illustrates step (bii) of the disclosed method, wherein the pressed powder of step (bi) (9) is heated and subjected to hot-pressing to form a compact body (10) by first loading (6) the pressed powder from step b(i) (9), hot pressing the powder (7) and unloading the compacted powder (8). FIG. 1(d) illustrates step (c) of the disclosed method, wherein the compact body of step (bii) (10) is subjected to hot-deforming by first loading (12) the compact body of step b(ii), hot deforming the compact body (13), to obtain a die-upset magnet (15) and unloading it (14). FIG. 1(e) illustrates step (d) of the disclosed method, wherein crushing of die-upset magnet of step (d) (15) results in a powder (16). FIG. 1(f) illustrates step (e) of the disclosed method, milling and sieving of the powder of step (d) (16) resulting in a milled and sieved powder (17). FIG. 1(g) illustrates step (f) of the disclosed method, passivating the powder of step (e) (17) to obtain a magnetic powder (18).

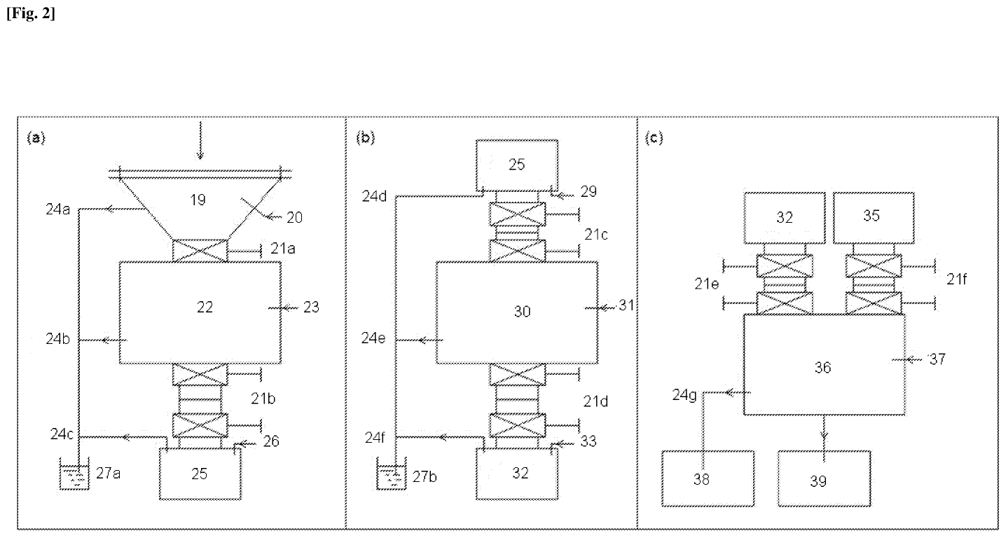

FIG. 2 shows a schematic of connection of the sealed transfer container to (a) crushing equipment, (b) milling and sieving equipment and (c) passivating equipment.

FIG. 2(a) shows a schematic of the sealed transfer from step (c) to step (d). A magnet feed (19) is connected to a crushing equipment (22) via an isolation valve (21a). The magnet feed (19) is purged with inert gas through an inert gas inlet (20) and out through a gas outlet (24a). The die-upset magnet of step (c) is released into the crushing equipment (22) without exposing to the outside environment by opening the isolation valve (21a). After the transfer, the crushing equipment (22) is disconnected from the magnet feed (1) by closing the isolation valve (21a). The crushing equipment (22) is further purged under inert gas by flowing inert gas throughout the equipment using a gas inlet (23) and gas outlet (24b). When the crushing step is completed, a second isolation valve (21b) is opened to release the crushed powder into a container (25). The container is purged with inert gas through an inert gas inlet (26) and out through a gas outlet (24c). The purged gas from the gas outlets (24a, 24b, 24c) flows to water tank (27a).

FIG. 2(b) shows a schematic of the sealed transfer from step (d) to step (e). The powder container (25) containing the crushed powder from step (d) is connected to a milling and sieving equipment (30) via an isolation valve (21c). The powder container (25) is purged with inert gas through an inert gas inlet (29) and out through a gas outlet (24d). The crushed powder of step (d) is released into the milling and sieving equipment (30) without exposing to the outside environment by opening the isolation valve (21c). After the transfer, the milling and sieving equipment (30) is disconnected from the powder container (25) by closing the isolation valve (21c). The milling and sieving equipment (30) is further purged under inert gas by flowing inert gas throughout the equipment using a gas inlet (31) and gas outlet (24e). When the milling and sieving step is completed, a second isolation valve (21d) is opened to release the crushed powder into a container (32). The container is purged with inert gas through an inert gas inlet (33) and out through a gas outlet (24f). The purged gas from the gas outlets (24d, 24e, 24f) flows to water tank (27b).

FIG. 2(c) shows a schematic of the sealed transfer from step (e) to step (f). The powder container (32) containing the sieved powder from step (e) is connected to passivating equipment (36) via an isolation valve (21e). A container containing passivating agent (35) is connected to the passivating equipment (36) via another isolation valve (21f). The sieved powder of step (e) (32) and the passivating agent (35) is released into the passivating equipment (36) without exposing to the outside environment by opening the isolation valves (21e, 21f). After the transfer, the passivating equipment (36) is disconnected from the powder and passivating agent containers (32, 35) by closing the isolation valves (21e, 21f). The passivating equipment (36) is further purged under inert gas by flowing inert gas throughout the equipment using a gas inlet (37) and gas outlet (24g) by a vacuum pump (38). When the passivating step is completed, the magnetic powder is released into a container (39).

### EXAMPLES

Non-limiting examples of the invention and a comparative example will be further described in greater detail by reference to specific Examples, which should not be construed as in any way limiting the scope of the invention.

### Materials

NdPr obtained from Ganzhou Rare Earth Metals Ltd.

FeB obtained from Lioyang International Penghejin Limited Company.

Fe and Ga obtained from Alfa Aesar.

Li-St obtained from Valtris Specialty Chemicals Limited.

### Example 1: Preparation of Alloy Magnetic Powder

Melt-Spun Powder (Step (a))

A rapidly solidified alloy composition is prepared by weighing an appropriate amount of raw material (Nd, Fe, Ga, Fe—B) according to formula (I) as disclosed herein. The raw material is placed into a melter for melting under argon atmosphere and subsequently cooled to obtain ingots. After which, the ingots are broken into pieces and loaded into a melt-spinner. The ingots are heated up and re-melted under argon atmosphere before ejecting onto a rotating metal wheel to form ribbons. Following which, the melt-spun ribbons are crushed to powder form.

Cold Press (Step Bi))

Before cold pressing, a lubricant (LiSt) is mixed with melt-spun powder.

Internal lubed melt-spun powder is pressed into a cold-pressed powder using a hydraulic cold press. Cold pressing is performed at room temperature and under normal atmosphere.

Hot Press (Step b(ii))

The cold-pressed powder is lubricated with an alcohol mixture before putting into a hot press die cavity. The alcohol mixture is prepared from graphite, boron nitride and alcohol. The alcohol mixture is sprayed onto the cold-pressed powder and the alcohol is evaporated by exposing the powder to a ventilation cabinet.

Hot pressing is performed under argon protection (i.e. inert atmosphere) to achieve a full dense magnet. The hot pressing stage is purged by argon gas to minimize oxidation amid the hot-pressing process.

Hot Deformation (Step (c))

After hot-pressing, the hot-pressed compact body is immediately feed into a hot deformation feeder for about 60% to about 80% die-upset hot deformation. The hot deformation step is performed under inert atmosphere.

Sandblasting

Die-upset magnets are first sandblasted to remove the surface dirt and lubricant before crushing.

Sealed Transfer

Each of the steps from crushing to passivating (steps (d) to step (f)) are conducted under low oxygen environment (below 0.5 weight % oxygen) and the transfer between each of steps (d) to (f) is a sealed transfer. The inert gas used is nitrogen. The oxygen content of the low oxygen environment and during each sealed transfer is below 0.5 weight %.

Crushing (Step (d))

During the jaw crushing step, big pieces of die-upset magnets are broken down into smaller pieces under nitrogen protection. The smaller pieces of magnets are better feed for the milling step.

Sieving and Milling (Step (e))

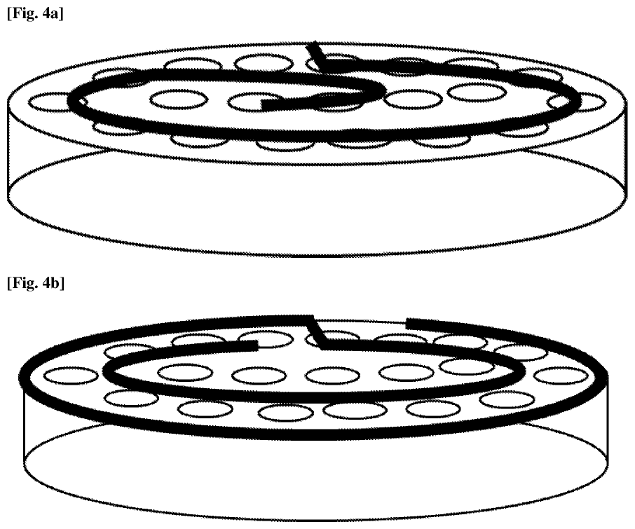

The crushed die-upset magnets are milled and then sieved to the desired particle size through the use of means for prolonging the residence time of the particles on the sieve unit (for example, by using a sieve bar as depicted in FIG. 4a or 4b) under nitrogen purging and sealed transfer, with oxygen content below 0.5%.

Passivating (Step (f))

The magnetic powder is treated with phosphoric acid in a mixer for anti-aging and passivating effect. The passivating mixer is subjected to vacuum and nitrogen purging repeatedly to decrease the oxygen level. Next, the powder and phosphoric acid are fed into the mixer chamber for mixing and heating.

### Example 2: Properties of Magnetic Alloy Powders

Alloy powders formed by the method of Example 1 and their magnetic properties are shown in Table 1:

TABLE 1

| | Sample | | | | | | | Br | Hci | (BH)max | Oxygen |
|---|---|---|---|---|---|---|---|---|---|---|---|
| | name | NdPr | Dy | Ga | Co | B | Fe | (kG) | (kOe) | (MGOe) | (wt %) |
| Magnetic powder of | 2a | 30.45 | — | 0.53 | — | 0.94 | 68.08 | 13.3 | 14.5 | 38.9 | ~0.5-0.6 |
| present invention | 2b | 31.45 | — | 0.53 | — | 0.93 | 67.09 | 13.0 | 16.9 | 38.2 | |
| (Example 1) | 2c | 31.90 | — | 0.63 | — | 0.92 | 66.55 | 12.7 | 18.9 | 36.8 | |
| | 2d | 32.40 | — | 0.78 | — | 0.91 | 65.91 | 12.5 | 19.5 | 36.2 | |

### Example 3: Effect of Phosphating on Hazard Rating of Magnetic Powder

In step (f), the powder of step (e) may be subjected to passivating with phosphoric acid.

The inventors have surprising found that at least 0.25 wt % of phosphoric acid is effective and sufficient in protecting the magnetic powder from oxidation. Metal oxidation is undesirable as metal oxides, unlike metals, do not exhibit magnetic properties. Conventionally, the phosphating step prevents the oxidation of iron in the magnetic powder to iron oxide. Using 0.25 wt % of phosphoric acid for passivation not only prevents magnetic powder from forming undesired iron oxide but also prevents magnetic powder from forming neodymium oxide. Reducing oxidation of both neodymium and iron is beneficial as it improves magnetic performance of the magnetic powder. Also advantageously, using at least 0.25 wt % of phosphoric acid allows a phosphate protective layer to be formed around each metal particle without such corroding the particles.

The disclosed method may also comprise passivating the powder with phosphoric acid at a concentration of 0.4 wt %. The inventors have surprisingly found that by passivating the magnetic powder in 0.4 wt % of phosphoric acid, the resultant magnetic powder may be non-hazardous which allows it to be safely handled and transported (Table 2).

The testing basis of the Hazardous Test performed on the magnetic powders was based on the UN Recommendations on the Transport of Dangerous Goods (19^{th} revised edition), UN Globally Harmonized System of Classification and Labelling of Chemicals (6^{th} revised edition) and China's Catalogue of Hazardous Chemicals (CHC), published by the State Administration of Work Safety (SAWS) on 9 Mar. 2015 and entered into force on 1 May 2015.

The results of the Hazardous Test may be found in Table 2 below.

TABLE 2

| Phosphoric Acid | | |
|---|---|---|
| on MQA (wt. %) | MQA Br Loss (%) | Hazardous Test |
| 0.00 | 0.0 | Hazardous |
| 0.20 | −0.4 | Hazardous |
| 0.25 | −0.5 | Hazardous |
| 0.30 | −0.7 | Hazardous |
| 0.40 | −0.8 | Non-hazardous |
| 0.50 | −0.9 | Non-hazardous |

### Comparative Examples

### Comparative Example 1: Method of Preparing Comparative Magnetic Powders

Comparative Samples 1a, 1b, 1c and 1d were prepared according to the steps set out in Table 3 below. The differences between the method for preparing Samples 1a, 1b, 1c and 1d and the method for preparing Samples 2a, 2b, 2c and 2d are also set out in Table 3.

TABLE 3

| | Method of Example 1 | Comparative Method | |
|---|---|---|---|
| Steps | (Samples 2a, 2b, 2c, 2d) | (Samples 1a, 1b, 1c, 1d) | Difference |
| Melt-spun | A rapidly solidified alloy | A rapidly solidified alloy | |
| powder | composition is prepared | composition is prepared by | |
| (Step (a)) | by weighing an | weighing an appropriate | |
| | appropriate amount of raw | amount of raw material | |
| | material (Nd, Fe, Ga, Fe—B) | (Nd, Fe, Ga, Fe—B) | |
| | according to formula | according to formula (I) as | |
| | (I) as disclosed herein. | disclosed herein. The raw | |
| | The raw material is placed | material is placed into a | |
| | into a melter for melting | melter for melting under | |
| | under argon atmosphere | argon atmosphere and | |
| | and subsequently cooled | subsequently cooled to | |
| | to obtain ingots. After | obtain ingots. After which, | |
| | which, the ingots are | the ingots are broken into | |
| | broken into pieces and | pieces and loaded into a | |
| | loaded into a melt-spinner. | melt-spinner. The ingots | |
| | The ingots are heated up | are heated up and re- | |
| | and re-melted under argon | melted under argon | |
| | atmosphere before ejecting | atmosphere before ejecting | |
| | onto a rotating metal | onto a rotating metal wheel | |
| | wheel to form ribbons. | to form ribbons. Following | |
| | Following which, the | which, the melt-spun | |
| | melt-spun ribbons are | ribbons are crushed to | |
| | crushed to powder form. | powder form. | |
| Cold press | Before cold pressing, a | Before cold pressing, a | |
| (Step bi)) | lubricant (LiSt) is mixed | lubricant (LiSt) is mixed | |
| | with melt-spun powder. | with melt-spun powder. | |
| Hot press | The cold-pressed powder | The cold-pressed powder | Example 1 is |
| (Step b(ii)) | is lubricated with an | is lubricated with an | performed under |
| | alcohol mixture before | alcohol mixture before | inert atmosphere, |
| | putting into a hot press | putting into a hot press | while the |
| | die cavity. The alcohol | die cavity. The alcohol | Comparative |
| | mixture is prepared from | mixture is prepared from | Method is |
| | graphite, boron nitride | graphite, boron nitride | performed under |
| | and alcohol. The alcohol | and alcohol. The alcohol | partial inert |
| | mixture is sprayed onto | mixture is sprayed onto | atmosphere. |
| | the cold-pressed powder | the cold-pressed powder | |
| | and the alcohol is | and the alcohol is | |
| | evaporated by exposing | evaporated by exposing | |
| | the powder to a | the powder to a | |
| | ventilation cabinet. | ventilation cabinet. | |
| | Hot pressing is | Hot pressing is performed | |
| | performed under argon | only under argon purging | |
| | protection (i.e. inert | to achieve a full dense | |
| | atmosphere) to achieve a | magnet. The hot pressing | |
| | full dense magnet. The | stage is performed under | |
| | hot pressing stage is | partial inert atmosphere. | |
| | purged by argon gas to | | |
| | minimize oxidation amid | | |
| | the hot-pressing process. | | |
| Hot | After hot-pressing, the | After hot-pressing, the | Example 1 is |
| deformation | hot-pressed compact | hot-pressed compact body | performed under |
| (Step (c)) | body is immediately feed | is immediately feed into a | inert atmosphere, |
| | into a hot deformation | hot deformation feeder | while the |
| | feeder for about 60% to | for about 60% to about | Comparative |
| | about 80% die-upset hot | 80% die-upset hot | Method is |
| | deformation. The hot | deformation. The hot | performed in air. |
| | deformation step is | deformation step is | |
| | performed under inert | performed in air. | |
| | atmosphere. | | |
| Sandblasting | Die-upset magnets are | Die-upset magnets are | |
| | first sandblasted to | first sandblasted to | |
| | remove the surface dirt | remove the surface dirt | |
| | and lubricant before | and lubricant before | |
| | crushing. | crushing. | |
| Sealed | The transfer between | No sealed transfer. | The transfer |
| transfer | each of the steps from | | between each of |
| | crushing to passivating | | steps (d) to (f) of |
| | (steps (d) to step (f) is a | | Example 1 is a |
| | sealed transfer where the | | sealed transfer, |
| | oxygen content during | | while the transfer |
| | each sealed transfer is | | between steps (d) |
| | below 0.5 weight %. | | to (f) of the |
| | | | Comparative |
| | | | Method is not a |
| | | | sealed transfer and |
| | | | the contents are |
| | | | exposed to air. |
| Crushing | During the jaw crushing | During the jaw crushing | |
| (Step (d)) | step, big pieces of die- | step, big pieces of die- | |
| | upset magnets are broken | upset magnets are broken | |
| | down into smaller pieces | down into smaller pieces | |
| | under nitrogen | under nitrogen protection. | |
| | protection. The smaller | The smaller pieces of | |
| | pieces of magnets are | magnets are better feed | |
| | better feed for the milling | for the milling step. | |
| | step. | | |
| Sieving and | The crushed die-upset | The crushed die-upset | Example 1 uses a |
| milling | magnets are milled and | magnets are milled and | means for |
| (Step (e)) | then sieved to the desired | then sieved. | prolonging the |
| | particle size through the | | residence time of |
| | use of means for | | the particles on the |
| | prolonging the residence | | sieve unit, whereas |
| | time of the particles on | | the Comparative |
| | the sieve unit (for | | Method does not |
| | example, by using a sieve | | use such means |
| | bar as depicted in FIGS. | | (i.e. normal sieving |
| | 4a or 4b). | | process). |
| Passivating | The magnetic powder is | The magnetic powder is | |
| (Step (f)) | treated with phosphoric | treated with phosphoric | |
| | acid in a mixer for anti- | acid in a mixer for anti- | |
| | aging and passivating | aging and passivating | |
| | effect. The passivating | effect. The passivating | |
| | mixer is subjected to | mixer is subjected to | |
| | vacuum and nitrogen | vacuum and nitrogen | |
| | purging repeatedly to | purging repeatedly to | |
| | decrease the oxygen | decrease the oxygen level. | |
| | level. Next, the powder | Next, the powder and | |
| | and phosphoric acid are | phosphoric acid are fed | |
| | fed into the mixer | into the mixer chamber | |
| | chamber for mixing and | for mixing and heating. | |
| | heating. | | |

Samples 2a to 2d were prepared as shown in Example 1 which is under a low oxygen environment, using sealed transfer between steps (d) to (f) and using means for prolonging the residence time of the particles on the sieve unit in step (e). As a result, Samples 2a to 2d have a lower oxygen content than Comparative Samples 1a to 1d.

Advantageously, Dy and Co are absent from the magnetic powder of Samples 2a to 2d, yet they achieve comparable or even better Hci when compared to Comparative Samples 1a to 1d (Table 4). For example, Sample 2d exhibits high Hci exceeding 19 kOe without using dysprosium, which is higher when compared to Comparative Samples 1b and 1c.

In addition, Sample 2c shows an improvement of Br magnetic performance by about 0.4 kG when compared to Comparative Sample 1c. Sample 2b also surprisingly shows an improvement of Br magnetic performance by about 0.5 kG when compared to Comparative Sample 1d, even though Sample 2b and Comparative Sample 1d share the same composition.

TABLE 4

| | | | | | | | | Br | Hci | (BH)max | Oxygen |
|---|---|---|---|---|---|---|---|---|---|---|---|
| | Sample name | NdPr | Dy | Ga | Co | B | Fe | (kG) | (kOe) | (MGOe) | (wt %) |
| Comparative magnetic | Comparative | 30.4 | — | 0.61 | 4.00 | 0.92 | 64.07 | 12.9 | 13.7 | 36.1 | ~0.9 |
| powder | Sample 1a | | | | | | | | | | |
| | Comparative | 29.50 | 1.60 | 0.61 | 2.00 | 0.92 | 65.37 | 12.5 | 16.0 | 34.5 | |
| | Sample 1b | | | | | | | | | | |
| | Comparative | 27.50 | 3.60 | 0.61 | 2.00 | 0.92 | 65.37 | 12.3 | 18.9 | 33.5 | |
| | Sample 1c | | | | | | | | | | |
| | Comparative | 31.45 | | 0.53 | | 0.93 | 67.09 | 12.5 | 16.7 | 34.6 | |
| | Sample 1d | | | | | | | | | | |
| Magnetic powder of | 2a | 30.45 | — | 0.53 | — | 0.94 | 68.08 | 13.3 | 14.5 | 38.9 | ~0.5-0.6 |
| present invention | 2b | 31.45 | — | 0.53 | — | 0.93 | 67.09 | 13.0 | 16.9 | 38.2 | |
| (Example 1) | 2c | 31.90 | — | 0.63 | — | 0.92 | 66.55 | 12.7 | 18.9 | 36.8 | |
| | 2d | 32.40 | — | 0.78 | — | 0.91 | 65.91 | 12.5 | 19.5 | 36.2 | |

### Comparative Example 2: Low Oxygen Sealed Transfer Process

Sample 2b was prepared by low oxygen sealed transfer during milling step, while Comparative Sample 1d of the same composition was prepared under standard transfer process which exposes the powder to air during milling.

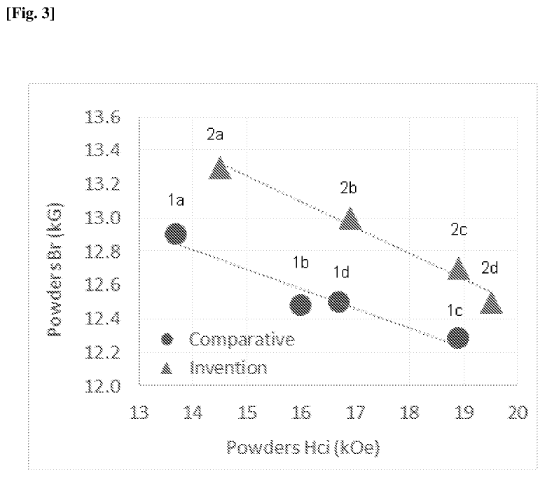

Table 5 and FIG. 3 shows that Sample 2b exhibits 0.4 wt % lower oxygen content and 0.5 kG higher Br as compared to Sample 1d. This may be attributed to the low oxygen sealed transfer process with reduces oxidation of magnetic powder and therefore improves Br.

The oxygen reduction in magnetic powder of the present invention (Example 1) is mainly attributed to oxygen-free sealed transfer during milling. As shown in Table 5, the total oxygen content in the magnetic powder is reduced from 0.92 wt % to 0.45 wt % by using low oxygen sealed transfer.

TABLE 5

| Method | MQA Br (kG) | Oxygen (wt. %) |
|---|---|---|
| Sample 1d | 12.5 | 0.92 |
| Sample 2b | 13.0 | 0.45 |

### Comparative Example 3: Particle Size of Magnetic Powder

Table 6 shows the difference in magnetic properties between different particle sizes of magnetic powders of −80 mesh and −80 mesh to −325 mesh. A wider particle size is observed for −80 mesh. Table 6 shows that fine powders (−325 mesh, <45 um) exhibits poorer magnetic performance and higher oxygen content.

TABLE 6

| | Sample | | | Br | Hci | (BH)max | Oxygen |
|---|---|---|---|---|---|---|---|
| | no. | Particle size | | (kG) | (kOe) | (MGOe) | (wt. %) |
| Comparative | 1d | −80 to −325 | mesh | 12.7 | 16.9 | 36.5 | 0.75 |
| magnetic powders | 1d | −80 | mesh | 12.5 | 16.7 | 34.6 | 0.92 |
| | 1d | −325 | mesh | 12.0 | 15.9 | 29.3 | 1.52 |
| Magnetic powder | 2b | −80 to −325 | mesh | 13.0 | 17.0 | 39.0 | 0.37 |
| of present | 2b | −80 | mesh | 13.0 | 16.8 | 38.4 | 0.45 |
| invention | 2b | −325 | mesh | 12.4 | 16.1 | 32.4 | 0.98 |

The range of particle sizes obtained may be achieved by controlling the extent of sieving. In particular, this by including means for prolonging the residence time of the particles on the sieve unit, less fine particles (i.e. −325 mesh) particles can be obtained.

One such means for prolonging the residence time of the particles on the sieve unit is by utilizing an elongated flexible member which coils around the top of the sieving platform to extend the journey path of the particles. Embodiments of such a member are shown in FIGS. 4a and 4b (sieve bar).

Through the use of such means, a reduction from 35% to 30% in the portion of fine particles (i.e. −325 mesh) can be achieved as shown in Table 7. Reducing the portion of fine particles in the magnetic powder helps to improve the overall magnetic properties of magnetic powder as shown above in Table 7.

TABLE 7

| | | |
|---|---|---|
| Weight % | Sample 1d | Sample 2b |

| | | | |
|---|---|---|---|
| −325 | mesh | 35% | 30% |
| −80 to −325 | mesh | 65% | 70% |

### INDUSTRIAL APPLICABILITY

The disclosed alloy powder may advantageously exhibit improved magnetic properties, for example, high Bᵣ and H_{ci} values. The alloy powder may be used for high performance bonded magnets.

Advantageously, the disclosed alloy powder may not require the use of expensive rare earth metals, for example, Dy or Co, which translates to cost-savings.

Advantageously, the methods for making the disclosed alloys of the present disclosure may produce alloys with lower oxygen content and improved magnetic properties such as high Hci and Br.

More advantageously, the method of the present disclosure may produce alloys with reduced portion of fines and improved magnetic properties.

Further advantageously, the method of the present disclosure may allow more effective phosphate treatment of alloys without degradation, leading to better anti-oxidation and non-hazardous properties.

The disclosed alloys, magnetic materials or bonded magnets with superior magnetic properties may be used in numerous applications, including computer hardware, automobiles, consumer electronics, motors and household appliances.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. An alloy powder with Formula (I) and oxygen content less than 0.9 wt %:
RE-M-B—Fe Formula (I)
wherein:
RE is one or more rare earth metals selected from the group consisting of lanthanum (La), cerium (Ce), neodymium (Nd), praseodymium (Pr), yttrium (Y), gadolinium (Gd), terbium (Tb), dysoprium (Dy), holmium (Ho), and ytterbium (Yb);
M is one or more metals selected from the group consisting of gallium (Ga), zirconium (Zr), niobium (Nb), molybdenum (Mo), titanium (Ti), vanadium (V), chromium (Cr), manganese (Mn), hafnium (Hf), tantalum (Ta), tungsten (W), aluminum (Al), and cobalt (Co);
B is boron (B); and
Fe is iron (Fe);
wherein:
RE is in the range of 29.0 weight % to 33.0 weight %;
M is in the range of 0.25 weight % to 1.0 weight %;
B is in the range of 0.8 weight % to 1.1 weight %; and
Fe makes up the balance,
wherein the alloy powder is an anisotropic magnetic powder, and wherein the anisotropic magnetic powder exhibits a remanence (Br) value greater than 12 kG at a coercivity (Hci) value in the range of 14 kOe to 20 kOe.

2. The alloy powder of claim 1, wherein the oxygen content is in the range of 0.5 wt % to 0.6 wt %.

3. The alloy powder of claim 1, wherein at most 30% of the particles are −325 mesh; or wherein 30% of the particles are −325 mesh, and 70% of the particles are −80 to −325 mesh.

4. (canceled)

5. (canceled)

6. (canceled)

7. The alloy powder of claim 15, wherein the anisotropic magnetic powder exhibits a remanence (Br) value greater than 13 kG at a coercivity (Hci) value of 15 kOe, about 13 kG at 17 kOe, about 12.7 kG at 19 kOe, and about 12.5 kG at 19.5 kOe.

8. The alloy powder of claim 1, wherein RE is selected from the group consisting of:
(i) Nd;
(ii) Nd, Pr;
(iii) Nd, Pr, La;
(iv) Nd, Pr, Ce;
(v) Nd, Pr, La, Ce;
(vi) Nd, La;
(vii) Nd, Ce;
(viii) Nd, Ce, La;
(ix) Pr;
(x) Pr, La;
(xi) Pr, Ce; and
(xii) Pr, La, Ce.

9. The alloy powder of claim 1, wherein Formula (I) is selected from the group consisting of:
(i) Nd—Ga—Fe—B;
(ii) Pr—Ga—Fe—B;
(iii) (NdPr)—Ga—Fe—B;
(iv) Nd—Al—Fe—B;
(v) Pr—Al—Fe—B; and
(vi) (NdPr)—Al—Fe—B.

10. The alloy powder of claim 1, wherein cobalt (Co) or dysprosium (Dy) is absent.

11. The alloy powder of claim 1, wherein RE is in the range of 30.0 wt % to 32.5 wt %, M is in the range of 0.50 weight % to 0.75 weight %, B is in the range of 0.9 weight % to 1.0 weight %, and Fe makes up the balance or wherein RE is in the range of 30.40 weight % to 32.45 weight %, M is in the range of 0.45 weight % to 0.55 weight %, B is in the range of 0.885 weight % to 0.945 weight %, and Fe makes up the balance.

12. (canceled)

13. The alloy powder of claim 1, wherein the alloy composition is selected from the group consisting of:
NdPr—Ga—B—Fe, wherein RE is 30.45 wt %, Ga is 0.53 wt %, B is 0.94 wt %, and Fe is 68.08 wt %;
NdPr—Ga—B—Fe, wherein RE is 31.45 wt %, Ga is 0.53 wt %, B is 0.93 wt %, and Fe is 67.09 wt %;
NdPr—Ga—B—Fe, wherein RE is 31.9 wt %, Ga is 0.63 wt %, B is 0.92 wt %, and Fe is 66.55 wt %; and
NdPr—Ga—B—Fe, wherein RE is 32.4 wt %, Ga is 0.78 wt %, B is 0.91 wt %, and Fe is 65.91 wt %.

14. A bonded magnet comprising the alloy powder of claim 1 and at least one binder selected from the group consisting of epoxy, polyamide, and polyphenylene sulfide.

15. A method for preparing a RE-M-Fe—B magnetic powder, wherein:
RE is one or more rare earth metals selected from the group consisting of lanthanum (La), cerium (Ce), neodymium (Nd), praseodymium (Pr), yttrium (Y), gadolinium (Gd), terbium (Tb), dysoprium (Dy), holmium (Ho), and ytterbium (Yb);
M is one or more metals selected from the group consisting of gallium (Ga), zirconium (Zr), niobium (Nb), molybdenum (Mo), titanium (Ti), vanadium (V), chromium (Cr), manganese (Mn), hafnium (Hf), tantalum (Ta), tungsten (W), copper (Cu), and aluminum (Al), and cobalt;
B is boron (B); and
Fe is iron (Fe);
wherein the method comprises the steps of:
(a) melt spinning a RE-M-Fe—B alloy composition to obtain a melt-spun powder;
(b) pressing the melt-spun powder of step (a) to obtain a compact body;
(c) hot deforming the compact body of step (b) to obtain a die-upset magnet;
(d) crushing the die-upset magnet of step (c) to obtain a powder;
(e) milling and sieving the powder of step (d); and
(f) passivating the powder of step (e) to obtain a magnetic powder;
wherein:
each of steps (d) to (f) is performed under a low oxygen environment and transfer between each of steps (d) to (f) is a sealed transfer;
wherein the oxygen content of the low oxygen environment and during each sealed transfer is below 0.5 weight %, and
wherein the sealed transfer is carried out using a container comprising means for sealed connection with equipment used in steps (d) to (f), means for sealed collection and release from the container after each step; and means for supplying an inert gas into the container.

16. The method of claim 15, wherein each of steps (c) to (f) is performed under a low oxygen environment.

17. The method of claim 15, wherein the oxygen content of the low oxygen environment and during each sealed transfer is below 0.1 weight %.

18. The method of claim 15, wherein step (e) comprises sieving the powder on a sieve unit comprising means for prolonging the residence time of said powder on said sieve unit.

19. The method of claim 15, wherein step (f) comprises passivating the powder with phosphoric acid at a concentration of at least 0.25 wt % or at a concentration of at least 0.40 wt %.

20. (canceled)

21. (canceled)

22. The method of claim 15, wherein the inert gas may be selected from a group consisting of argon, nitrogen, helium, and mixtures thereof.

23. The method of claim 15, wherein step (b) comprises the steps of:
(bi) cold pressing the melt-spun powder of step (a); and
(bii) hot pressing the cold-pressed powder of step (bi) to form the compact body.

24. The method of claim 22, wherein step (bii) is performed in inert atmosphere comprising argon, nitrogen, helium, or mixtures thereof.

25. The method of claim 15, wherein the oxygen content of the RE-M-Fe—B magnetic powder is less than 0.9 weight %; or wherein the oxygen content of the RE-M-Fe—B magnetic powder is in the range of 0.5 weight % to 0.6 weight %.

26. (canceled)

27. The method of claim 15, wherein the RE-M-Fe—B magnetic powder is an alloy powder with Formula (I) and oxygen content less than 0.9 wt %:
RE-M-B—Fe Formula (I)
wherein:
RE is one or more rare earth metals selected from the group consisting of lanthanum (La), cerium (Ce), neodymium (Nd), praseodymium (Pr), yttrium (Y), gadolinium (Gd), terbium (Tb), dysoprium (Dy), holmium (Ho), and ytterbium (Yb);
M is one or more metals selected from the group consisting of gallium (Ga), zirconium (Zr), niobium (Nb), molybdenum (Mo), titanium (Ti), vanadium (V), chromium (Cr), manganese (Mn), hafnium (Hf), tantalum (Ta), tungsten (W), aluminum (Al), and cobalt (Co);
B is boron (B); and
Fe is iron (Fe):
wherein:
RE is in the range of 29.0 weight % to 33.0 weight %;
M is in the range of 0.25 weight % to 1.0 weight %;
B is in the range of 0.8 weight % to 1.1 weight %; and
Fe makes up the balance,
wherein the alloy powder is an anisotropic magnetic powder, and wherein the anisotropic magnetic powder exhibits a remanence (Br) value greater than 12 kG at a coercivity (Hci) value in the range of 14 kOe to 20 kOe.
